(19) United States
(12) Patent Application Publication
(10) Pub. No.: US 2018/0025707 A1
(43) Pub. Date: Jan. 25, 2018

(54) Ultimate Thumb Pick, for stringed musical instruments

(71) Applicants: Paul Richard Gustafson, Winnsboro, TX (US); Robert Eric Gustafson, Midlothian, TX (US)

(72) Inventors: Paul Richard Gustafson, Winnsboro, TX (US); Robert Eric Gustafson, Midlothian, TX (US)

(21) Appl. No.: 14/999,946

(22) Filed: Jul. 19, 2016

(51) Int. Cl. G10D 3/16

(52) U.S. Cl. CPC G10D 3/163

(57) ABSTRACT

The invention is generally a thumb pick apparatus for playing a stringed musical instrument having an elastic and generally cylindrically shaped cot having an opening and a tip, and having a substantially uniform thickness, with a side “pick pocket” attached thereto proximate to the cylindrical side of the cot, capable of encapsulating and “hugging” the user's plectrum of choice while allowing said plectrum to extend beyond the side of the cot at an approximate right angle such that the plectrum is capable of plucking a string of a musical instrument when the cot is being worn on a thumb digit of a user with the pick pocket holding the plectrum firmly in place.

### CLAIM OF PRIORITY

This application claims priority to U.S. Provisional Patent Application No. 62/195,785 to common inventor Gustafson et al, dated 22 Jul. 2015 and entitled, “Ultimate Thumb Pick, for stringed musical instruments”.

This application will also reference U.S. Pat. No. 8,502,053, which claimed priority to U.S. Provisional Patent Application No. 61/455,119 to common inventor Gustafson et al, dated 15 Oct. 2010 and entitled, “‘Ultimate’ fingerpick: ‘finger nailer’ fingerpick ‘awesome pluckers’ fingerpick: fingerpicks to be used on stringed musical instruments.”

### FIELD OF THE INVENTION

The present invention relates to picks for stringed instruments.

### Problem Statement

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

Picks for stringed instruments have been around since ancient times. The sound each stringed instrument generates is unique and different compared to the sound generated when the same instrument is strummed. Conventional flat picks are commonly held between one's thumb and forefinger, with sound being generated through strumming. A variation to this method, known as “finger picking” has evolved over the years and increased in popularity. However, finger picking involves plucking the strings with one's fingernails, which can lead to torn nails, bleeding, and pain. Not only is there a need in the art for devices that enable finger picking without damage to one's own fingers and nails, but there is also a need for a similar device for the very unique digit known as the human thumb, which generally plucks the strings from a different angle, compared to the upstroke of the human fingers. The present invention is just that very device, solving the special needs specific to the thumb.

### BRIEF DESCRIPTION OF THE DRAWINGS

The following detailed description will aid in the understanding of various aspects of the invention, as well as an embodiment. We utilized the cot embodiment from our existing U.S. Pat. No. 8,502,053, and then proceeded in a completely unique and unobvious direction to accommodate the unique needs of the human thumb. The detailed description, given by way of examples and not intended to limit the present invention solely thereto, will be better understood when read in conjunction with the drawings, wherein like reference numerals denote like elements and parts in which:

FIG. 1 is an isometric view of the preferred embodiment of the apparatus according to the teachings of the invention, and from the thumb nail side of the apparatus.

FIG. 2 is a thumb nail side view of the apparatus disposed on a thumb digit and depicted with a standard-sized plectrum inserted in the “pick pocket”.

FIG. 3 is a front view of the apparatus disposed on a thumb digit, showing the placement of the pick pocket designed to encapsulate and “hug” the plectrum-of-choice of the user.

### EXEMPLARY EMBODIMENT OF A BEST MODE

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from the following exemplary structure (or a following exemplary act) that a substantially equivalent structure or substantially equivalent act may be used to either achieve the same results in substantially the same way, or to achieve the same results in a not dissimilar way.

Second, the only essential aspects of the invention are identified by the claims. Thus, aspects of the invention, including elements, acts, functions, and relationships (shown or described) should not be interpreted as being essential unless they are explicitly described and identified as being essential.

Third, a function or act should be interpreted as incorporating all modes of doing that function or act, unless otherwise explicitly stated (for example, one recognizes that “tacking” may be done by nailing, stapling, gluing, hot gunning, riveting, etc., and so a use of the word “tacking” invokes nailing, stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the invention is also described in view of the Festo decisions, and, in that regard, the claims and the invention incorporate equivalents known, unknown, foreseeable, and unforeseeable.

Sixth, the language and each word used in the invention should be given the ordinary interpretation of the language and the word, unless indicated otherwise. As will be understood by those of ordinary skill in the art, various structures and devices are depicted in block diagram form in order to avoid unnecessarily obscuring the invention.

It should be noted in the following discussion that acts with like names are performed in like manners, unless otherwise stated. Of course, the foregoing discussions and definitions are provided for clarification purposes and are not limited. Words and phrases are to be given their ordinary plain meaning unless indicated otherwise.

### DETAILED DESCRIPTION OF THE DRAWINGS

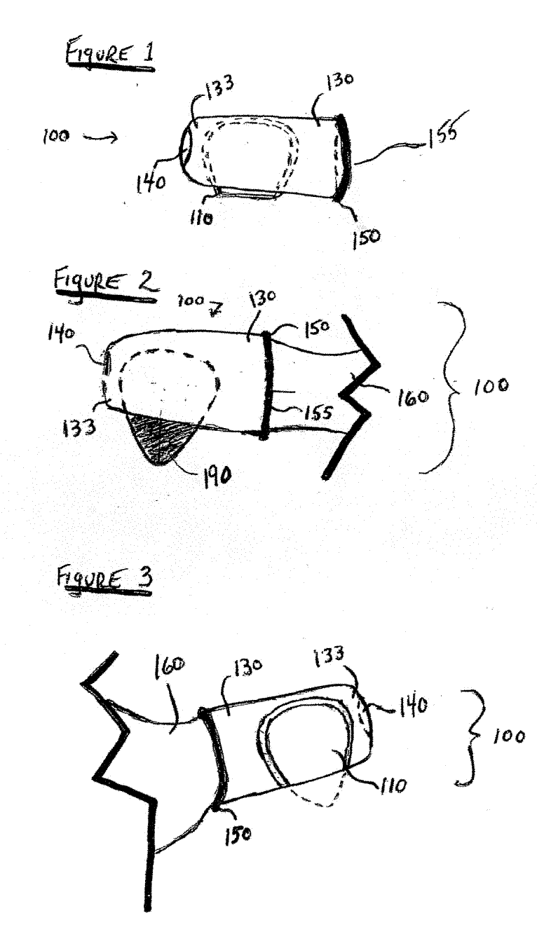

FIG. 1 is an isometric view of the preferred embodiment of the apparatus according to the teachings of the invention. FIG. 2 is a side view of the apparatus, disposed upon a thumb. The following description is made in simultaneous reference to FIG. 1, FIG. 2 and FIG. 3: In a preferred embodiment the invention is a pick apparatus 100 for playing a stringed musical instrument, such as a guitar, banjo, autoharp, or mandolin, for example. As is most clearly seen in the bottom view FIG. 3, the apparatus 100 includes a generally cylindrically shaped cot 130 terminating in a hemisphere 133 with a tip breath hole 140 and being shaped to tightly accommodate a human digit 160 therein.

The cot 130 is made of an elastic material that “hugs” the digit (finger or thumb) 160 of the user, such as rubber, nitrile material, plastics, latex or similar materials (herein, “cot” is used in the “sheath or protective covering” sense of the word, and not in its “bedding” sense). The cot 130 is in varying embodiments as long as the proximate, intermediate or distal portions of a human digit. The cot has an opening 155, a tip 133, and a breath hole 140, and has a substantially uniform thickness, preferably ranging from 13 to 40 mils (thousandths of an inch). The cot may be smooth and unbroken, perforated, with or without breath-holes. FIG. 1 best displays a tip breath hole 140 designed to increase the ease of the placement/removal of the invention on the user's digit, as well as allowing the exposure of the tip of the human digit. The opening 155 of the cot 130 is preferably reinforced via a rim 150 of the same material as the cot 130, and may be uniformly part of the cot 130, similar to the terminal stem of a balloon. FIG. 3 The apparatus 100 also includes a “pick pocket” 110, preferably of the same material as the cot 130, and may be uniformly part of the cot 130, designed to encapsulate and “hug” a plectrum, with a sufficient portion of the plectrum extending away from the cot at an approximate right angle to the length-wise cylindrical body of the cot, and capable of plucking a string of a musical instrument. FIG. 2 best illustrates a conventional plectrum 190 inserted into the pick pocket 110 and extending away from the cot disposed on a thumb digit. This allows the plectrum to strike the strings of a musical instrument when the cot is being worn on the thumb and as the thumb moves in close proximity above and somewhat parallel to the strings being plucked. (“close proximity above and somewhat parallel to the strings being plucked” is a common style of play among finger pickers who incorporate a thumb pick to increase their finger picking skills).

In the preferred embodiment, the pick pocket 110 allows the user to interchange a variety of plectrums, made of a variety of materials, in order to “draw out” different sounds from the instrument being played or for purely ornamental reasons. As an example, a banjo player might insert a metal plectrum into the pick pocket 110, especially if the user utilizes metal finger picks, so as to produce more uniformity in tonal qualities between fingers and thumb. A selected plectrum 190 might also be attached by the end-user, with an adhesive, such as a cyanoacrylate, or polyurethane, or some type of fusing bonding agent, making it a permanent addition to the invention.

Furthermore, though the invention has been described with respect to a specific preferred embodiment, many advantages, variations and modifications will become apparent to those skilled in the art upon reading the present application. It is therefore the intention that the appended claims and their equivalents be interpreted as broadly as possible in view of the prior art, to include all such variations and modifications.

We claim:

1. A pick apparatus for playing a stringed musical instrument, comprising: a generally cylindrically shaped cot termination in a hemisphere being shaped to tightly accommodate a human digit; the cot comprising an elastic material; the cot has an opening and a tip, and has a substantially uniform thickness; a pick pocket attached to the cot proximate to the cylindrical side of the cot designed to encapsulate and “hug” a plectrum while holding it at an approximate right angle to the lengthwise side of said cot, with a sufficient portion of the plectrum extending beyond the side of the cot capable of plucking a string of a musical instrument when the cot is being worn on a digit of a user; wherein the cot is at least as long as the intermediate and distal portions of a human digit.

2. A pick apparatus for playing a stringed musical instrument, comprising: a generally cylindrically shaped cot termination in a hemisphere being shaped to tightly accommodate a human digit; the cot comprising an elastic material; the cot has an opening and a tip, and has a substantially uniform thickness; a pick pocket attached to the cot proximate to the cylindrical side of the cot designed to encapsulate and “hug” a plectrum while holding it at an approximate right angle to the lengthwise side of said cot, with a sufficient portion of the plectrum extending beyond the side of the cot capable of plucking a string of a musical instrument when the cot is being worn on a digit of a user; wherein the cot is at least as long as the proximate, intermediate and distal portions of a human digit.

3. A thumb pick apparatus for playing a stringed musical instrument, comprising: a generally cylindrically shaped cot termination in a hemisphere being shaped to tightly accommodate a human thumb digit; the cot comprising an elastic material; the cot has an opening and a tip, and has a substantially uniform thickness; a pick pocket attached to the cot proximate to the cylindrical side of the cot designed to encapsulate and “hug” a plectrum while holding it at an approximate right angle to the lengthwise side of said cot, with a sufficient portion of the plectrum extending beyond the side of the cot capable of plucking a string of a musical instrument when the cot is being worn on the thumb digit of a user; wherein the cot is at least as long as the intermediate and distal portions of a human thumb digit.

4. A thumb pick apparatus for playing a stringed musical instrument, comprising: a generally cylindrically shaped cot termination in a hemisphere being shaped to tightly accommodate a human thumb digit; the cot comprising an elastic material; the cot has an opening and a tip, and has a substantially uniform thickness; a pick pocket attached to the cot proximate to the cylindrical side of the cot designed to encapsulate and “hug” a plectrum while holding it at an approximate right angle to the lengthwise side of said cot, with a sufficient portion of the plectrum extending beyond the side of the cot capable of plucking a string of a musical instrument when the cot is being worn on the thumb digit of a user; wherein the cot is at least as long as the proximate, intermediate and distal portions of a human thumb digit.
